(19) United States
(12) Patent Application Publication
(10) Pub. No.: US 2026/0116279 A1
(43) Pub. Date: Apr. 30, 2026

(54) SEAT FOR VEHICLE

(71) Applicants: Hyundai Motor Company, Seoul (KR); Kia Corporation, Seoul (KR); SEOYON E-HWA CO., LTD., Anyang-si, Gyeonggi-do (KR)

(72) Inventors: Ji Seob PARK, Hwaseong-si (KR); Ji Ah KIM, Hwaseong-si (KR); Ji Yun HA, Hwaseong-si (KR); Jin Ho HWANG, Hwaseong-si (KR); Jae Moon JEONG, Namyangju-si (KR)

(21) Appl. No.: 19/187,437

(22) Filed: Apr. 23, 2025

(30) Foreign Application Priority Data
Oct. 28, 2024 (KR) 10-2024-0148247

(51) Int. Cl. B60N 2/90; B60N 2/02; B60N 2/75

(52) U.S. Cl. CPC B60N 2/90; B60N 2/02253; B60N 2/797; B60N 2002/924

(57) ABSTRACT

A seat for a vehicle is disclosed. The seat for a vehicle includes a partition assembly located adjacent to a seat, an armrest assembly located adjacent to the partition assembly, a driving mechanism configured to selectively apply a driving force to the partition assembly and the armrest assembly, and a controller configured to apply electricity to the driving mechanism in response to a user request. The partition assembly includes a frame fixed to a base, a partition located at the frame, and a partition link located between the partition and the driving mechanism.

### CROSS REFERENCE TO RELATED APPLICATION

The present application claims priority to Korean Patent Application No. 10-2024-0148247, filed on Oct. 28, 2024, the entire contents of which are incorporated herein for all purposes by this reference.

### TECHNICAL FIELD

The present disclosure relates to a seat for a vehicle and, more particularly, to a seat for a vehicle, which includes an armrest assembly and a partition assembly and is capable of controlling the armrest assembly and the partition assembly.

### BACKGROUND

A vehicle is equipped with seats on which passengers sit. The seats may be equipped with armrests where passengers on the seats can place arms to improve ride comfort.

For instance, the existing armrest may be one armrest member rotatably coupled to the seat. Specifically, the armrest may operate such that the passenger on the seat rotates the armrest to adjust an angle of the armrest. In some cases, various installation angles of the armrest may not be implemented in response to a seating position of the passenger, and a manual operation may cause inconvenience.

In some cases, partitions in vehicles may be provided separately from the armrests and have a fixed structure that is difficult to extend in a height direction or a longitudinal direction in response to user requests.

An integrated driving relationship between adjacent components may enable the armrest position to change in conjunction with the operation of the partition. For instance, the partition and armrest positions may be adjusted in response to the user's seat position.

### SUMMARY

The present disclosure describes a seat for a vehicle, which is capable of selectively performing integral driving of an armrest assembly and a partition assembly with one driving mechanism.

The present disclosure further describes a structure in which a partition assembly is unfolded in a forward direction and a height direction in response to a seat position and an armrest assembly moves forward and downward in response to a seat height.

According to one aspect of the subject matter described in this application, a seat for a vehicle includes a partition assembly located adjacent to the seat, an armrest assembly located adjacent to the partition assembly, a driving mechanism configured to apply a driving force to the partition assembly and the armrest assembly, and a controller configured to apply electricity to the driving mechanism in response to a user request. The partition assembly includes a base, a frame fixed to the base, a partition located at the frame, and a partition link located between the partition and the driving mechanism.

Implementations according to this aspect can include one or more of the following features. For example, the partition link can include a main link coupled to the driving mechanism, a first transfer link located between a first end of the main link and the partition and configured to perform a longitudinal movement in response to a rotatory force of the driving mechanism, and a second transfer link located between a second end of the main link and the partition and configured to perform vertical movement in response to the rotatory force of the driving mechanism.

In some implementations, the armrest assembly can include an armrest located adjacent to the partition assembly, an armrest link coupled to the main link and disposed adjacent to the first transfer link, and an armrest hinge link located at the armrest and coupled to the armrest link.

In some implementations, the seat can further include an armrest frame located at the base, an armrest block located at a rear end of the armrest, and a guide located between the armrest block and the armrest frame. In some examples, the armrest can be configured to, based on the rotatory force of the driving mechanism being applied, move in a moving direction of the armrest link, and the armrest block can be configured to, based on the rotatory force of the driving mechanism being applied, move along with the guide.

In some examples, the guide has a predetermined angle with respect to the base to enable the armrest to move in a parallel state with respect to the base. In some implementations, the seat can further include a bush that is located at the armrest block and covers the guide.

In some implementations, the armrest link can define a slot, where the seat further can include a protrusion disposed at the main link and inserted into the slot, and a position control device configured to restrict movement of the protrusion in the slot. For example, the position control device can include a pin configured to be inserted into the slot.

In some implementations, the armrest link and the main link can be configured to move integrally with each other based on the pin of the position control device being inserted into the slot to thereby restrict a position of the protrusion. In some examples, the controller can be configured to control the position control device in response to driving requests of the armrest assembly and the partition assembly to thereby rotate the armrest link integrally with the main link.

In some implementations, the controller can be configured to drive the driving mechanism in response to a seat reclining request of a user. In some examples, the driving mechanism can include an output shaft connected to the main link, and the main link can include a first sub link coupled to the first transfer link, and a second sub link coupled to the second transfer link.

In some examples, the first sub link can extend in a first direction from a portion connected to the output shaft, and the second sub link can extend in a second direction from the portion connected to the output shaft, the second direction is different from the first direction. In some examples, the first sub link and the second sub link defines a predetermined angle therebetween about the output shaft. In some examples, a length of the first sub link can be less than a length of the second sub link.

In some implementations, the seat of the present disclosure has the effect of providing seat comfort performance by implementing the heights of the partition assembly and the armrest assembly in response to the user seat position.

In some implementations, the seat of the present disclosure has the effect of increasing user convenience by implementing the partition assembly and the armrest assembly operated selectively or in conjunction.

In some implementations, the seat of the present disclosure has the effect of increasing the spatial efficiency of the vehicle with the structure that can drive the partition assembly and the armrest assembly separately or simultaneously with one driving mechanism.

### BRIEF DESCRIPTION OF THE DRAWINGS

FIG. 1 is a view illustrating an example of a partition assembly and an armrest assembly included in an example of a seat of a vehicle.

FIG. 2 is a view illustrating an example of a position relationship of the armrest assembly in a reclining seat position.

FIG. 3 is a view illustrating an example configuration including the partition assembly and the armrest assembly.

FIG. 4 is an exploded view illustrating the partition assembly.

FIG. 5 is an exploded view illustrating the armrest assembly.

FIG. 6 is an exploded view illustrating the partition assembly before use.

FIG. 7 is a view illustrating an example of an unfolded state of the partition assembly.

FIGS. 8A and 8B are views illustrating an example of a coupling structure between a main link and an armrest link when a pin of a position control device is unfolded.

FIGS. 9A and 9B are views illustrating an example of a coupling structure between the main link and the armrest link when the pin of the position control device is released.

### DETAILED DESCRIPTION

Hereinbelow, one or more example implementations of the present disclosure will be described in detail with reference to accompanying drawings.

The terms used in the specification “˜part”, “˜unit”, “module”, and the like may refer to a unit for processing at least one function or operation and may be implemented by a combination of hardware and/or software.

For example, a controller 500 may be implemented by an algorithm for controlling operation of various components provided in a vehicle or a memory that stores data about a program that reproduces the algorithm, and a processor that performs the above-described operations using the data stored in the memory. In some examples, the memory and the processor may be implemented with separate chips. Furthermore, the memory and the processor may be implemented with a simple chip. For example, the controller 500 may include an electronic control unit (ECU), a central processing unit (CPU), a microprocessor unit (MPU), a microcontroller unit (MCU), an application processor (AP), and at least one of an application processor (AP) or a processor. Furthermore, the controller 500 may include a combination of software and hardware that can perform calculation on at least one of application or program for executing a method of the present disclosure.

Hereinbelow, the implementations will be described in detail with reference to accompanying drawings, and when describing or referring the accompanying drawings, the same reference numerals will be used to refer to the same or like components, and description of those components will be omitted.

The present disclosure relates to a seat 10 for a vehicle. More particularly, the present disclosure relates to a partition assembly 100 located adjacent to the seat 10 for a vehicle and an armrest assembly 200 driven integrally with the partition assembly 100.

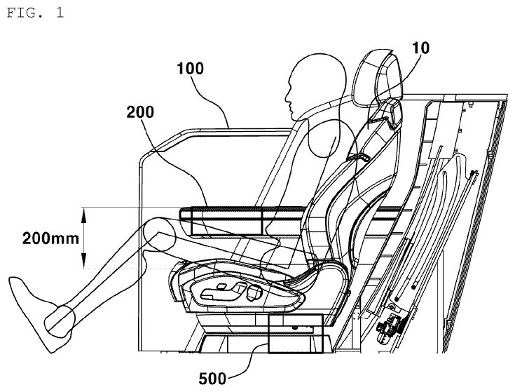

FIG. 1 is a view illustrating an example configuration of the seat 10 for a vehicle, the partition assembly 100, and the armrest assembly 200.

In some implementations, the seat 10 for a vehicle includes one or more partition assemblies 100 partitioning one seat 10. Furthermore, the partition assembly 100 includes the armrest assembly 200 movable longitudinally and vertically in the vehicle.

The partition assembly 100 includes a partition 120 provided in a frame 110, and a partition link 130 coupled to the partition 120 so that a driving force of a driving mechanism 300 is applied to the partition 120. When the driving force of the driving mechanism 300 is applied, through the partition link 130, the partition 120 is unfolded forward and rearward in a longitudinal direction of a vehicle and upward and downward in a height direction.

Furthermore, the armrest assembly 200 is located to be selectively movable along the partition 120. The armrest assembly 200 includes an armrest 210 on which a user's arm may be placed, and when the rotatory force of the driving mechanism 300 is applied, the armrest 210 may be moved forward in the longitudinal direction and downward in the height direction of the vehicle.

A controller 500 can be provided for a vehicle and can include an electronic control unit (ECU) or a controller for a seat 10. In some examples, the controller 500 may include an electric circuit, a control interface, a manipulator, one or more buttons, one or more levers, a display panel, etc.

When a user request is applied, the controller 500 may drive the partition assembly 100 or/and the armrest assembly 200. In some examples, when the controller 500 receives a driving request for reclining the seat 10 or an unfolding request of the partition 120 as a user request, the controller 500 may apply electricity from a vehicle battery to the driving mechanism 300.

In some examples, seat reclining refers to moving a seat to a position where a seat back is unfolded rearward beyond a preset angle and a front end of a seat cushion is raised to form a predetermined angle of the seat cushion in response.

Furthermore, the controller 500 controls a pin of a position control device 270, and may preset movement of the armrest assembly 200 integrally or selectively with the partition 120.

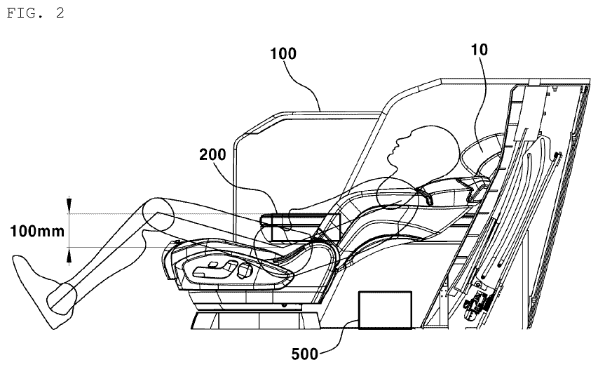

FIG. 2 illustrates the height and longitudinal change of the armrest 210 in the reclining seat position.

When the controller 500 has received the user input or request, the controller 500 may perform reclining of the seat 10 and change a height and a longitudinal position of the armrest assembly 200 in response to an angular change of the seat 10 according to the reclining of the seat 10.

In some examples, the armrest assembly 200 may move integrally with the partition assembly 100. Moreover, the controller 500 may control the position control device 270 so that only the partition assembly 100 is independently unfolded forward in a longitudinal direction of a vehicle and upward in a height direction.

In some examples, the driving mechanism 300 can include a motor configured to generate power, a shaft, a gear, links, etc. For example, in some implementations, the driving mechanism 300 can include a main link 131 as the partition link 130, and the driving mechanism 300 can perform a forward movement in the longitudinal direction of the partition 120 through a first transfer link 141 coupled to the partition 120, and perform un upward movement in the height direction of the partition 120 through a second transfer link 142. In addition, the driving mechanism 300 may perform forward movement and downward movement in the height direction of the armrest 210 through an armrest link 220 coupled to the main link 131.

In some examples, as a height between a sitting part of the seat and the armrest 210 is changed from 200 mm in a standing state as shown in FIG. 1 to 110 mm in a reclining state as shown in FIG. 2, the user sitting the reclining seat may be increased in the accessibility to the armrest 210.

Furthermore, the position control device 270 provides selective coupling between the main link 131 and the armrest assembly 200, which selectively drives the partition assembly 100 and the armrest assembly 200. In some examples, in response to the user's inputting or setting, the position control device 270 may only select unfolding of the partition assembly 100 or may select driving of both the partition assembly 100 and the armrest assembly 200.

In some examples, the driving mechanism 300 applies a driving force to the partition assembly 100 and may a driving force to both the partition assembly 100 and the armrest assembly 200.

In some implementations, when the controller receives the seat reclining request, the controller may apply a driving force to both the partition assembly 100 and the armrest assembly 200 through driving of the driving mechanism.

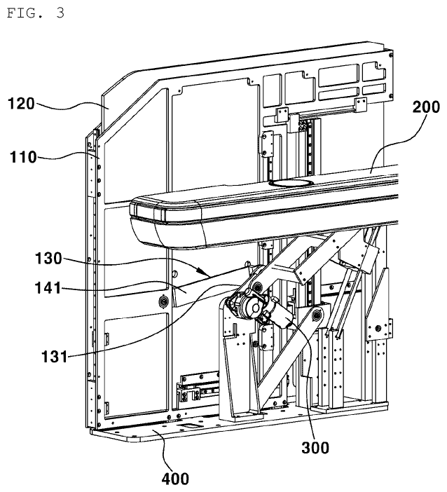

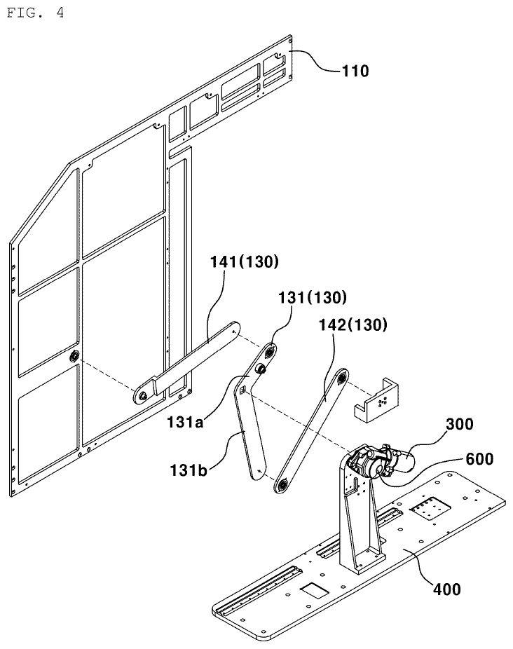

FIG. 3 is a view illustrating the configuration including the partition assembly 100 and the armrest assembly 200 of the seat 10 for a vehicle. FIG. 4 is an exploded view illustrating the partition assembly 100. Furthermore, FIG. 5 is an exploded view illustrating the armrest assembly 200.

The partition assembly 100 is located on at least one surface of the seat 10 for a vehicle, and the armrest assembly 200 may be located on one surface of the partition assembly 100 facing the seat 10. The partition assembly 100 includes the frame 110 located perpendicularly to the floor of the vehicle, and the partition 120 located inside the frame 110 and moving in response to a driving force of the driving mechanism 300.

The partition assembly 100 includes the main link 131 coupled to a rotary shaft of the driving mechanism 300, and a first end of the main link 131 includes the first transfer link 141. Furthermore, the first transfer link 141 is coupled adjacent to a front end of the partition 120. Furthermore, a second end of the main link 131 is coupled to the second transfer link 142 in an area adjacent to a lower end of the partition 120 before the driving mechanism 300 is operated.

The main link 131 includes a first sub link 131a coupled to the first transfer link 141 and a second sub link 131b coupled to the second transfer link 142 with a rotary shaft coupled to the driving mechanism 300 as the center. The first sub link 131a is relatively shorter than the second sub link 131b, and the first sub link 131a and the second sub link 131b may have a predetermined angle therebetween with the rotary shaft as the center. For example, the first sub link 131a can extend in a first direction from a portion connected to the output shaft 600, and the second sub link 131b can extend in a second direction from the portion connected to the output shaft 600, where the second direction is different from the first direction to define the predetermined angle.

Therefore, when the main link 131 rotates by the driving mechanism 300, a movement amount of the partition 120 moving forward in the longitudinal direction by the first transfer link 141 due to rotation of the first sub link 131a is configured to be relatively less than a movement amount of the partition 120 moving in the height direction through the second transfer link 142 due to rotation of the second sub link 131b.

In some examples, the length of the first sub link 131a and the second sub link 131b, and an angle formed by the first sub link 131a and the second sub link 131b mutually may be changed in consideration of the longitudinal movement amount and the height movement amount of the partition 120.

In some implementations, the driving mechanism 300 is securely coupled to a bracket based on a base 400. The opposite ends of the main link 131 located at the rotary shaft of the fixed driving mechanism 300 are respectively coupled to the first transfer link 141 and the second transfer link 142. Moreover, the main link 131 is coupled to the armrest link 220 such that the first end thereof coupled to the first transfer link 141 is adjacent thereto. A second end of the armrest link 220 is coupled to an armrest hinge link 230 located at the armrest 210. Therefore, the armrest 210 moves with the armrest hinge link 230 when the armrest hinge link 230 moves with the armrest link 220.

Furthermore, the armrest link 220 is located at the first sub link 131a, and when the main link 131 rotates, the armrest link 220 includes a moving path similar to the first transfer link 141. Therefore, the armrest 210 has a movement amount similar to the longitudinal movement amount of the partition 120.

Moreover, the armrest hinge link 230 is located to be coupled to the armrest 210 integrally with an armrest block 250. The armrest block 250 protrudes through a lower end of the armrest 210 and covers a guide 260 provided through the armrest block 250. Moreover, a bush 261 located at the armrest block 250 is provided, and the bush 261 is positioned in a form covering the guide 260.

Furthermore, the opposite ends of the guide 260 are fixed to armrest hinge links 240 coupled to the base 400. In some implementations, the armrest hinge links 240 are respectively located at front and rear ends of the armrest block 250 and fixed to the base 400. The guide 260 is coupled to the armrest hinge links 240 while being inclined.

In some implementations, when a driving force of the driving mechanism 300 is applied to the armrest 210, the armrest link 220 coupled to the main link 131 moves integrally with the armrest hinge link 230, and the armrest 210 coupled to the armrest hinge link 230 moves in the same direction as the moving direction of the armrest hinge link 230. Moreover, the armrest block 250 located at a rear end of the armrest 210 moves integrally with the armrest 210 in the inclined direction of the guide 260. Therefore, when a driving force of the driving mechanism 300 is applied, the armrest 210 remains in parallel in the longitudinal direction of the vehicle and moves forward in the longitudinal direction and downward in the height direction.

As described above, the armrest 210 is coupled to the armrest link 220 and moves forward and downward in a rotating direction of the main link 131, and the rear end of the armrest 210 includes the armrest block 250 coupled to the guide 260 so that the armrest 210 maintains a parallel state.

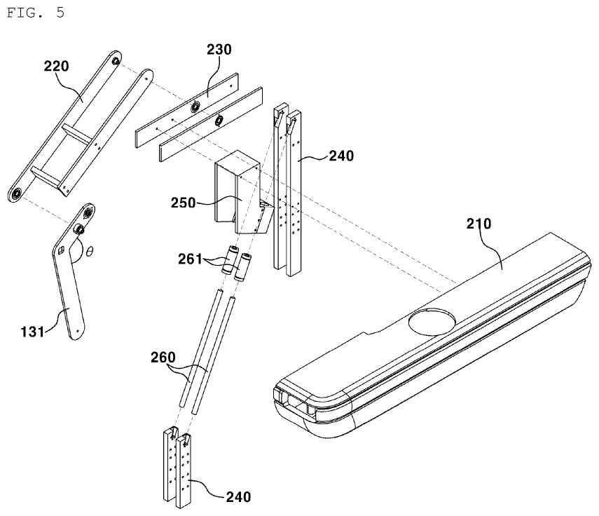

FIG. 6 is an exploded view illustrating before the partition assembly 100 and the armrest assembly 200 are unfolded.

In some implementations, the main link 131 coupled to the rotary shaft of the driving mechanism 300 has a first end located at a relatively upper end in the longitudinal direction and a second end located at a lower end in the longitudinal direction. Moreover, the armrest link 220 coupled to a position adjacent to one end of the main link 131 is provided.

While the first transfer link 141 is coupled to the partition 120 and the first end of the main link 131, the partition 120 is located inside the frame 110 when the main link 131 does not rotate. Furthermore, the second transfer link 142 is coupled to the second end of the main link 131 located adjacent to the base 400, so that the partition 120 is located inside the frame 110 in the height direction.

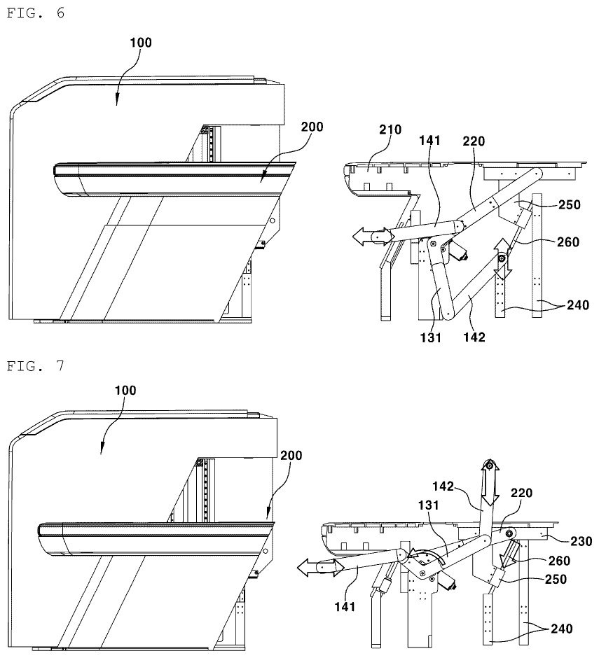

Thereafter, FIG. 7 illustrates positions of the partition 120 and the armrest 210 when current is applied to the driving mechanism 300.

In some implementations, when current is applied to the driving mechanism 300 and the driving mechanism 300 rotates counterclockwise, the main link 131 coupled to the rotary shaft of the driving mechanism 300 rotates in the same direction. Therefore, the first end of the main link 131 rotates from the right side to the left side of the driving mechanism 300, and the first transfer link 141 coupled to the first end of the main link 131 may apply a tension to the frame 110 so that the frame 110 moves in the longitudinal direction. In some implementations, the first end of the main link 131 coupled to the first transfer link 141 has the same height relationship before and after driving of the driving mechanism 300. Accordingly, the longitudinal movement amount of the first transfer link 141 is practically equal to the longitudinal movement amount of the partition 120.

In some examples, when the second end of the main link 131 is located at the lower end based on the base 400 as shown in FIG. 6, in response to the rotation of the driving mechanism 300, the second end of the main link 131 moves relatively upward in the height direction. Moreover, the second transfer link 142 coupled to the second end of the main link 131 moves integrally with the partition 120, so that the partition 120 may move in the height direction in response to the movement of the height direction of the second end of the main link 131.

In some examples, when the second end of the main link 131 moves in the height direction, the second end of the main link 131 is configured to have positions in the same longitudinal direction before and after driving of the driving mechanism 300. The movement amount in the height direction of the second end of the main link 131 is equal to the movement amount in the longitudinal direction of the partition 120.

Furthermore, the armrest link 220 is coupled adjacent to the first end of the main link 131 to which the first transfer link 141 is coupled, and moves the armrest 210 in the longitudinal direction in response to the rotation amount of the main link 131. Moreover, the armrest link 220 moves with a predetermined angle in response to rotation of the main link 131, and the armrest 210 moves forward and downward in response to the moving direction of the armrest link 220. In other words, the longitudinal movement amount of the armrest link 220 is relatively less than the movement amount of the partition 120, and is turned into a raised state along the lower end in the height direction.

In some implementations, the longitudinal movement amount of the armrest 210 is differently preset depending on the coupling position between the armrest link 220 and the main link 131, and the longitudinal movement amount and the height movement amount between the partition 120 and the armrest 210 may be changed.

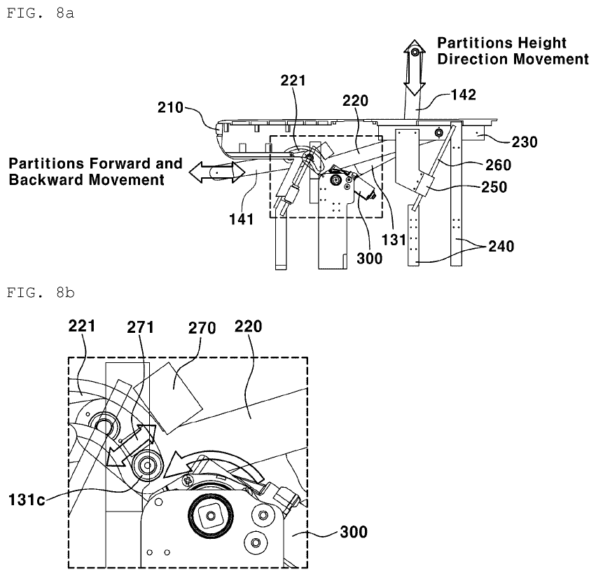

FIGS. 8A and 8B illustrate an example of the driving relationship of the seat 10 for a vehicle including the position control device 270, and a pin 271 of the position control device 270 is coupled into a slot 221 of the armrest link 220.

For example, the armrest link 220 is located adjacent to the main link 131, and a protrusion 131c of the main link 131 is located inside the slot 221 of the armrest link 220. In some implementations, the seat can include the position control device 270 located outside the armrest link 220 and having the pin 271 selectively inserted into the slot 221. The position control device 270 is configured to selectively insert the pin 271 into a hole located in the slot 221. In some examples, the pin 271 of the position control device 270 is mutually restricted with the protrusion 131c of the main link 131 so that the armrest link 220 and the main link 131 move integrally.

As illustrated in FIG. 8B, the protrusion 131c of the main link 131 is located in one end of the slot 221 adjacent to the position control device 270, and the pin 271 of the position control device 270 is inserted into the slot 221. In this case, the protrusion 131c of the main link 131 is located to be rotatable in the slot 221. When the main link 131 rotates, the protrusion 131c is configured to apply a rotatory force to the armrest link 220 integrally with the main link 131. In some examples, when the main link 131 and the armrest link 220 are coupled to each other, the protrusion 131c is configured to allow the armrest assembly 200 to move integrally with the unfolding of the partition assembly 100.

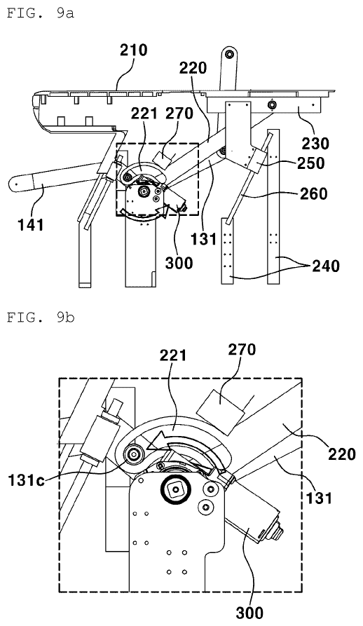

In some implementations, as illustrated in FIGS. 9A and 9B, the pin 271 of the position control device 270 is separated from the slot 221. In this case, when the partition assembly 100 is unfolded in the longitudinal direction and the height direction, a driving force of the driving mechanism 300 is not applied to the armrest assembly 200. In some examples, when the main link 131 rotates, the protrusion 131c located in a first internal end of the slot 221 may move to a second internal end of the slot 221 without movement of the armrest link 220.

In some examples, while a driving force of the driving mechanism 300 is not applied to the armrest link 220, the protrusion 131c may move along the inner portion of the slot 221. In other words, the slot 221 is formed to correspond to the moving path of the protrusion 131c, and a driving force of the driving mechanism 300 is not applied to the armrest link 220. Therefore, the partition 120 is unfolded in the longitudinal direction and the height direction of the vehicle, and the armrest 210 maintains the same position prior to the operation.

The detailed description is an example of the present disclosure. Furthermore, the exemplary implementation of the present disclosure has been described from the above-described contents, and the present disclosure can be used in many different combinations, variations, and environments. In other words, changes or modifications are possible within the scope of the patent disclosure disclosed in this specification, the scope equivalent to the disclosed contents described, and/or the scope of technology or knowledge in the art. The best mode for implementing the technical idea of the present disclosure has been described by the described implementation, and various modifications for specific application fields and uses of the present disclosure are also possible. Therefore, the above detailed description is not intended to limit the present disclosure to the disclosed implementation. Furthermore, it should be interpreted that the accompanying claims includes other implementations.

What is claimed is:

1. A seat for a vehicle, the seat comprising:
a partition assembly located adjacent to the seat;
an armrest assembly located adjacent to the partition assembly;
a driving mechanism configured to apply a driving force to at least one of the partition assembly or the armrest assembly; and
a controller configured to apply electricity to the driving mechanism in response to a user request,
wherein the partition assembly comprises:
a base,
a frame fixed to the base,
a partition located at the frame, and
a partition link located between the partition and the driving mechanism.

2. The seat of claim 1, wherein the partition link comprises:
a main link coupled to the driving mechanism;
a first transfer link located between a first end of the main link and the partition and configured to perform a longitudinal movement in response to a rotatory force of the driving mechanism; and
a second transfer link located between a second end of the main link and the partition and configured to perform vertical movement in response to the rotatory force of the driving mechanism.

3. The seat of claim 2, wherein the armrest assembly comprises:
an armrest located adjacent to the partition assembly;
an armrest link coupled to the main link and disposed adjacent to the first transfer link; and
an armrest hinge link located at the armrest and coupled to the armrest link.

4. The seat of claim 3, further comprising:
an armrest frame located at the base;
an armrest block located at a rear end of the armrest; and
a guide located between the armrest block and the armrest frame.

5. The seat of claim 4, wherein the armrest is configured to, based on the rotatory force of the driving mechanism being applied, move in a moving direction of the armrest link, and
wherein the armrest block is configured to, based on the rotatory force of the driving mechanism being applied, move along with the guide.

6. The seat of claim 4, wherein the guide has a predetermined angle with respect to the base to enable the armrest to move in a parallel state with respect to the base.

7. The seat of claim 4, further comprising:
a bush that is located at the armrest block and covers the guide.

8. The seat of claim 3, wherein the armrest link defines a slot, and
wherein the seat further comprises:
a protrusion disposed at the main link and inserted into the slot; and
a position control device configured to restrict movement of the protrusion in the slot, the position control device comprising a pin configured to be inserted into the slot.

9. The seat of claim 8, wherein the armrest link and the main link are configured to move integrally with each other based on the pin of the position control device being inserted into the slot to thereby restrict a position of the protrusion.

10. The seat of claim 8, wherein the controller is configured to control the position control device in response to driving requests of the armrest assembly and the partition assembly to thereby rotate the armrest link integrally with the main link.

11. The seat of claim 10, wherein the controller is configured to drive the driving mechanism in response to a seat reclining request of a user.

12. The seat of claim 2, wherein the driving mechanism comprises an output shaft connected to the main link, and
wherein the main link comprises:
a first sub link coupled to the first transfer link; and
a second sub link coupled to the second transfer link.

13. The seat of claim 12, wherein the first sub link extends in a first direction from a portion connected to the output shaft, and
wherein the second sub link extends in a second direction from the portion connected to the output shaft, the second direction is different from the first direction.

14. The seat of claim 12, wherein the first sub link and the second sub link defines a predetermined angle therebetween about the output shaft.

15. The seat of claim 12, wherein a length of the first sub link is less than a length of the second sub link.

16. The seat of claim 1, wherein the driving mechanism comprises at least one of a motor, a shaft, a gear, or links.

17. The seat of claim 3, wherein the armrest link defines a slot, and
wherein the seat further comprises:
a protrusion disposed at the main link and inserted into the slot; and
a pin configured to be inserted into the slot to thereby restrict movement of the protrusion in the slot.
